(19) United States
(12) Patent Application Publication
(10) Pub. No.: US 2015/0032571 A1
(43) Pub. Date: Jan. 29, 2015

(54) SYSTEM AND METHOD FOR PROVIDING CROSS-BORDER TRANSACTION BUYING ASSISTANCE

(71) Applicant: eBay Inc., San Jose, CA (US)

(72) Inventors: Marc Delingat, Mountain View, CA (US); Joseph Edward Black, Mountain View, CA (US); Yoram Vardi, Sunnyvale, CA (US); Frederick Ty, San Jose, CA (US)

(21) Appl. No.: 14/142,307

(22) Filed: Dec. 27, 2013

Related U.S. Application Data
(60) Provisional application No. 61/857,614, filed on Jul. 23, 2013.

(51) Int. Cl. G06Q 30/06

(52) U.S. Cl. CPC G06Q 30/0617; G06Q 30/0633
USPC 705/26.43

(57) ABSTRACT

In various embodiments, a system and method for providing cross-border transaction buying assistance are provided. In example embodiments, an option is presented to a cross-border buyer to purchase an item from a domestic networked commerce system using a buying agent. Based on a purchase of the item using the buying agent, instructions are sent to a seller of the item to ship the item to a domestic location corresponding to the buying agent. Once received by the buying agent, the buying agent is responsible for managing delivery of the item to the cross-border buyer from the domestic location.

### CROSS REFERENCE TO RELATED APPLICATION

The present application claims the priority benefit of U.S. Provisional Patent Application Ser. No. 61/857,614 filed on Jul. 23, 2013 and entitled “System and Method for Providing Cross-Border Transaction Buying Assistant,” which is incorporated herein by reference.

### FIELD

The present disclosure relates generally to a networked marketplace and, in a specific example embodiment, to providing a cross-border transaction buying assistance.

### BACKGROUND

Presently, cross-border trade or transaction (CBT) is increasingly recognized as an important channel for driving growth in ecommerce outside of the domestic (U.S.) market. Chief amongst issues found in CBT are payments, fulfillment/shipping, and language. With respect to payments, buyers may have an inability to pay in local currency on a locally available payment method. Additionally, some countries may still prefer cash-on-delivery. Fulfillment/shipping may be complicated by a shipping process made worse by long duration, high shipping cost, custom procedures, and opaque import duty calculations. Furthermore, a lack of localized content, whether with product information, merchandising collaterals, or service materials may be a result of language issues.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide cross-border transaction buying assistance.

FIG. 2 is a block diagram illustrating an example embodiment of a publication system.

FIG. 3 is a diagram illustrating an example CBT transaction flow.

FIGS. 4A-4F are example portions of screenshots illustrating an example cross-border buying assistant buyer flow.

FIG. 5 is a flowchart of an example method for providing cross-border buying assistance.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing cross-border trade or transaction (CBT) buying assistance. In some embodiments, an option is provided to a cross-border buyer (e.g., a buyer that is in a different jurisdiction or country from a seller) to purchase an item from a domestic (e.g., U.S. based) networked marketplace or commerce system (e.g., online marketplace) using a CBT buying assistant or agent (referred to as “buying agent”). In some embodiments, the buying agent may host a local (to the cross-border buyer) networked marketplace linked to the domestic networked marketplace. Based on an indication to purchase an item using the buying agent, a seller of the item is instructed to ship the item to a local location or a processing/forwarding facility that is in another country but within a same customs union (e.g., European Union) referred to as a “domestic location.” Accordingly, the buying agent may instruct the seller to ship the item to a facility associated with the buying agent that makes fulfillment of the order by the seller as easy and convenient for the seller as possible. The buying agent manages the shipping of the item across the border to the cross-border buyer and may provide additional services such as customs clearance, local delivery, temporary storage (e.g. in lockers), facilitation of payment, and customer support services to the buyer (e.g., managing returns). As such, the buying agent acts as an intermediary in a cross-border transaction.

While example embodiments are discussed with respect to an online marketplace, it is noted that any online or retail entity as well as individuals selling through online channels (e.g., a website, social media channel, mobile device application or similar online channel) may use operations discussed herein to facilitated cross-border transactions. Example embodiments may also be used in offline outlets (e.g., kiosks, showrooms with barcodes) for purposes of facilitating a cross-border or cross jurisdiction transaction. Each of these marketplaces, channels, and outlets may be referred to as a “networked commerce system.”

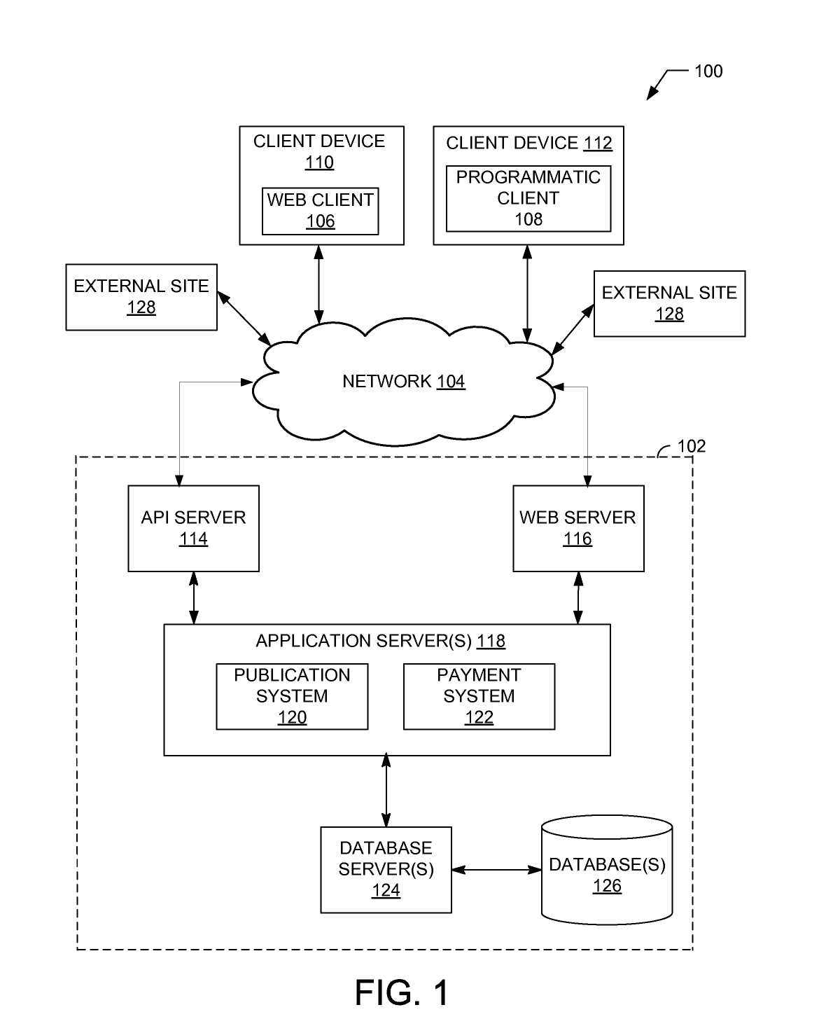

With reference to FIG. 1, an example embodiment of a high-level client-server-based network architecture 100 to enable a cross-border transaction buying assistant is shown. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client devices 110 and 112 may comprise a display module (not shown) to display information (e.g., in the form of user interfaces). In further embodiments, the client devices 110 and 112 may comprise one or more of a touch screen, accelerometer, camera, microphone, and Global Positioning System (GPS) device. The client devices 110 and 112 may each be a device of a user, which is used to perform a transaction involving digital goods within the networked system 102. In one embodiment, the networked system 102 is a network-based marketplace that manages digital goods, publishes publications comprising item listings of products available on the network-based marketplace, and manages payments for these marketplace transactions.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 are storage devices that store information to be posted (e.g., publications or listings) to the publication system 120. The databases 126 may also store digital goods information in accordance with example embodiments.

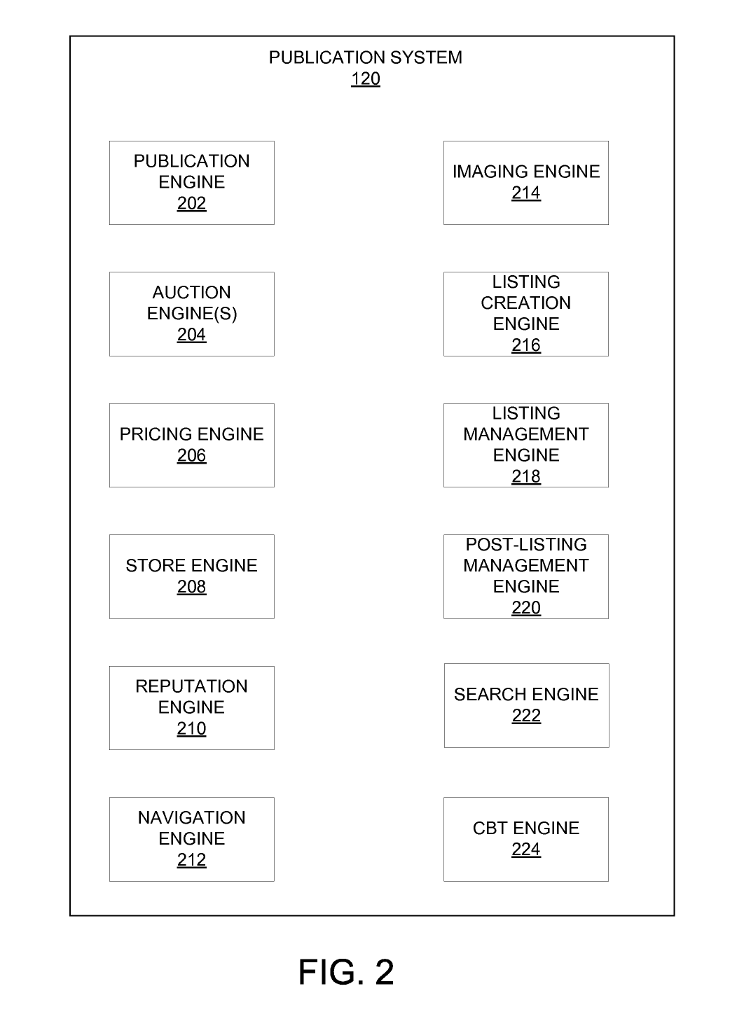

In example embodiments, the publication system 120 publishes content on a network (e.g., Internet). As such, the publication system 120 provides a number of publication and marketplace functions and services to users that access the networked system 102. The publication system 120 is discussed in more detail in connection with FIG. 2. In example embodiments, the publication system 120 is discussed in terms of an online marketplace environment. However, it is noted that the publication system 120 may be associated with a non-marketplace environment such as an informational (e.g., search engine) or social networking environment as well as offline marketplace environments.

The payment system 122 provides a number of payment services and functions to users. The payment system 122 allows users to accumulate value (e.g., in a commercial currency, such as the U.S. dollar, or a proprietary currency, such as points, miles, or other forms of currency provide by a private entity) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network-based marketplace.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one embodiment, are provided within the publication system 120 of the networked system 102 is shown. In one embodiment, the publication system 120 is a marketplace system where items (e.g., goods or services) may be offered for sale. The items may comprise digital goods (e.g., currency, license rights) and physical goods. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources to allow information to be passed between the components or to allow the components to share and access common data. Furthermore, the components may access the one or more databases 126 via the one or more database servers 124.

The publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, double, reverse auctions, etc.).

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both. In one embodiment, as part of a store, a buying agent may set up a virtual or real storefront that is connected to the networked system 102. The buying agent may offer through the storefront(s) inventory from one or more sellers from around the world in a way that makes it easy for a buyer to purchase goods from abroad. The buying agent may offer an explanation of his services in addition to descriptions of the goods in order to explain to the buyer the added value of buying through the buying agent rather than interacting with the seller directly. The buying agent may also offer to combine purchases by the buyer from multiple sellers into one shipment/transaction in order to ease the cross-border purchase.

A reputation engine 210 allows users that transact, utilizing the networked system 102, to establish, build, and maintain reputations. These reputations may be made available and published to potential trading partners. Because the publication system 120 supports person-to-person trading between unknown entities, in accordance with one embodiment, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness. For transactions involving a cross-border buying agent, the reputation engine 210 may be used to not only capture and reflect the reputations of the buyer and seller but also a reputation of the cross-border buying agent.

Navigation of the network-based marketplace may be facilitated by a navigation engine 212. For example, a browse module (not shown) of the navigation engine 212 allows users to browse various category, catalog, or inventory data structures according to which listings may be classified within the publication system 120. Various other navigation applications within the navigation engine 212 may be provided to supplement the browsing applications. In one embodiment, the navigation engine 212 may be used to decide which buyer may be best served by a cross-border buying agent and surface relevant information to the buyer based on a navigational behavior of the buyer and/or knowledge that the publication system 120 has about previous behavior of the buyer. Specific or implicit instructions of the seller related to cross-border transactions (e.g., countries the seller is willing to ship to) may be included in a decision by the navigation engine 212 on whether to display the information to the cross-border buyer or not.

In order to make listings available via the networked system 102 as visually informing and attractive as possible, the publication system 120 may include an imaging engine 214 that enables users to upload images for inclusion within publications and to incorporate images within viewed listings. The imaging engine 214 may also receive image data (e.g., a picture or scanned barcoded) from a user as a search query and utilize the image data to identify an item depicted or described by the image data.

A listing creation engine 216 allows users (e.g., sellers) to conveniently author listings of items. In one embodiment, the listings pertain to goods or services that a user (e.g., a seller) wishes to transact via the publication system 120. In other embodiments, a user may create a listing that is an advertisement or other form of publication.

A listing management engine 218 allows the users to manage such listings. Specifically, where a particular user has authored or published a large number of listings, the management of such listings may present a challenge. The listing management engine 218 provides a number of features (e.g., auto-relisting, inventory level monitors, etc.) to assist the user in managing such listings. In some embodiments, the listing engine 218 may allow the seller to specify whether his/her listings can be made available to countries/jurisdictions for sale through buying agents. The seller may be able to specify his preferences for or against specific buying agents by item, product, country/region, category, shipping method, and other criteria. The sellers may choose to do this in order to create a certain service level and/or brand presence for their goods (e.g. express delivery in premium packaging).

A post-listing management engine 220 also assists users with a number of activities that typically occur post-listing. For example, upon completion of a transaction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210. Another post-listing action may be shipping of sold items whereby the post-listing management engine 220 may assist in printing shipping labels, estimating shipping costs, and suggesting shipping carriers. In one embodiment, the seller may choose to use a buying agent in addition to a shipping provider to help with facilitation of a cross border transaction. In the case where a buyer has already picked a cross-border buying agent, the seller may receive specific instructions on how to fulfill the order without ultimately having to know all the logistics of how to deliver to the buyer abroad.

A search engine 222 performs searches for publications in the networked system 102 that match a query. In example embodiments, the search engine 222 comprises a search module (not shown) that enables keyword searches of publications published via the publication system 120. In a further embodiment, the search engine 222 may take an image received by the imaging engine 214 as an input for conducting a search. The search engine 222 takes the query input and determines a plurality of matches from the networked system 102 (e.g., publications stored in the database 126). In some embodiments, the search engine 222 may take information about a location of the item, the seller, the buyer, and/or the shipping destination into account to optimize the search results. The search engine 222 will also be able to take into account information about one or more cross-border buying agents to optimize the search results for the particular buyer. It is noted that the functions of the search engine 222 may be combined with the navigation engine 212.

A cross-border transaction (CBT) engine 224 manages cross-border transactions and the use of cross-border buying agents in the networked system 102. The various operations of the CBT engine 224 will be discussed in more detail below.

Although the various components of the publication system 120 have been defined in terms of a variety of individual modules and engines, a skilled artisan will recognize that many of the items can be combined or organized in other ways and that not all modules or engines need to be present or implemented in accordance with example embodiments. Furthermore, not all components of the publication system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

Example embodiments address the difficulties surrounding payment and fulfillment by implementing a concept of a CBT buying assistant or agent (“buying agent”). The use of the buying agent enhances a buying experience of an overseas or cross-border buyer when purchasing from a domestic seller on, for example, a U.S. based online marketplace. For example, a Chinese buyer may purchase an item from U.S. based eBay.com as if a transaction were a completely domestic transaction from a buyer's and seller's perspective in as far as payment and shipping are concerned. Sellers do not have to alter their sales practice, yet can gain additional customers practically with little or no incremental cost. Buyers can use their local payment method accompanied by local customer support. Central to this is the role of the buying agent and the technology and processes that accompany it that are provided by the CBT engine 224.

It is noted that example embodiments may be used in any marketplace or in any commerce transaction facilitated by a networked system (e.g., networked system 102). Thus, example embodiments may be applicable to buyers and sellers in any two jurisdictions in the world where payment, shipping, language, and customs constitute obstacles not customarily encountered for ecommerce within a same country/jurisdiction. Furthermore, in some embodiments, a buying agent may offer one or more services that overcome cross-border transaction hurdles, such as, payment method, delivery, customs clearance, customer support in local language, warranty services, and so forth.

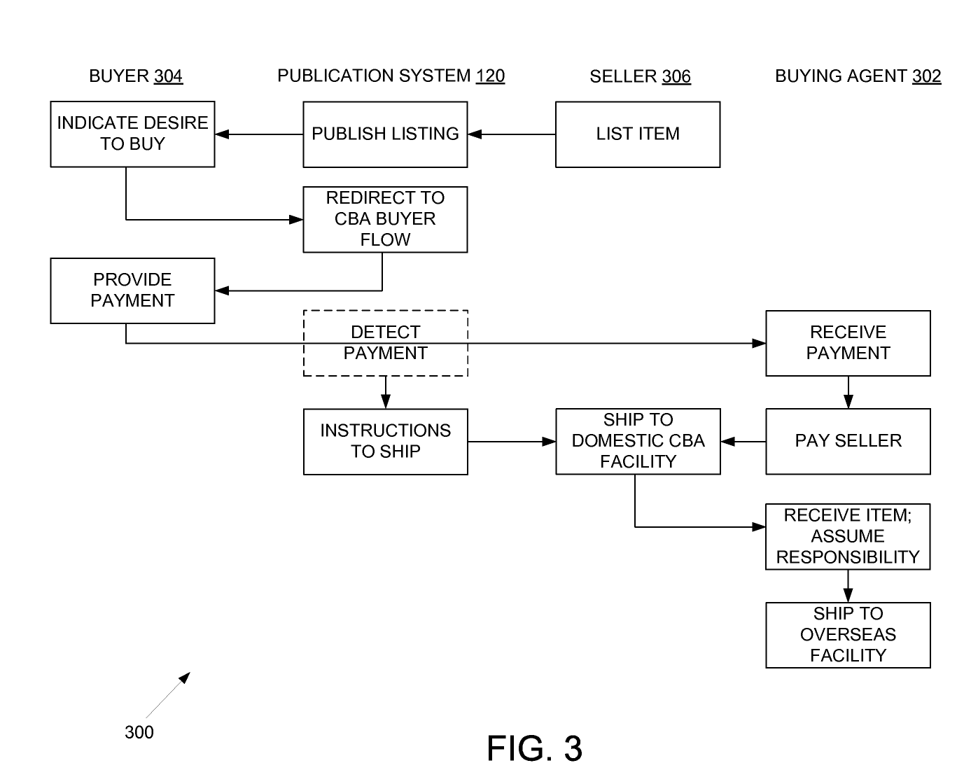

In one embodiment, the buying agent is an affiliate authorized by an online marketplace (e.g., networked system 102) to facilitate cross-border fulfillment. FIG. 3 is a diagram illustrating an example CBT transaction flow using a buying agent 302. The transaction flow assumes an overseas or cross-border buyer 304 desiring to purchase from a U.S. based online marketplace (e.g., the publication system 120) from a U.S. based seller 306. It is noted that the terms “trading” and “transaction” may be used interchangeably.

The seller 306 lists an item that the seller 306 wants to sell on the publication system 120. The publication system 120 publishes the listing, which the cross-border buyer 304 may view. The cross-border buyer 304 wants to purchase the item from the U.S. based online marketplace, and more particularly, from the U.S. based seller 306. As such, the cross-border buyer 304 may indicate, to the publication system 120, a desire to buy the item shown in the listing.

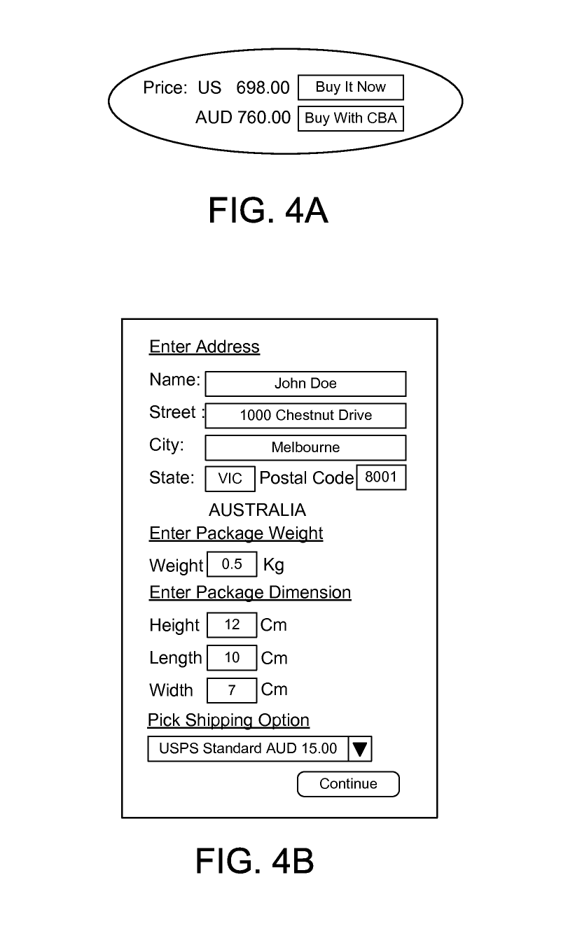

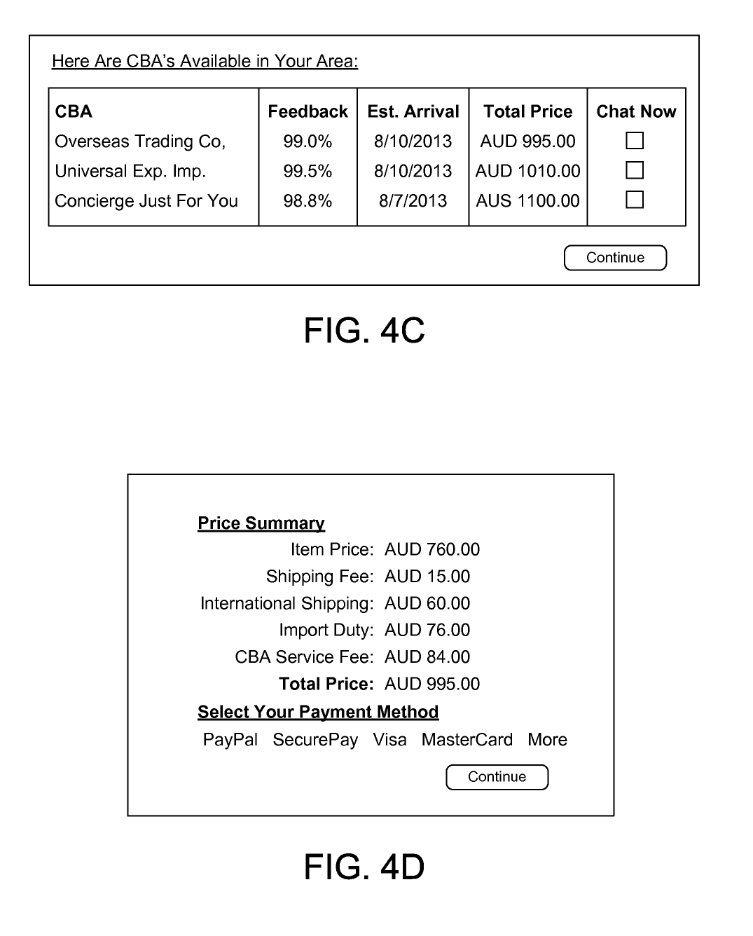

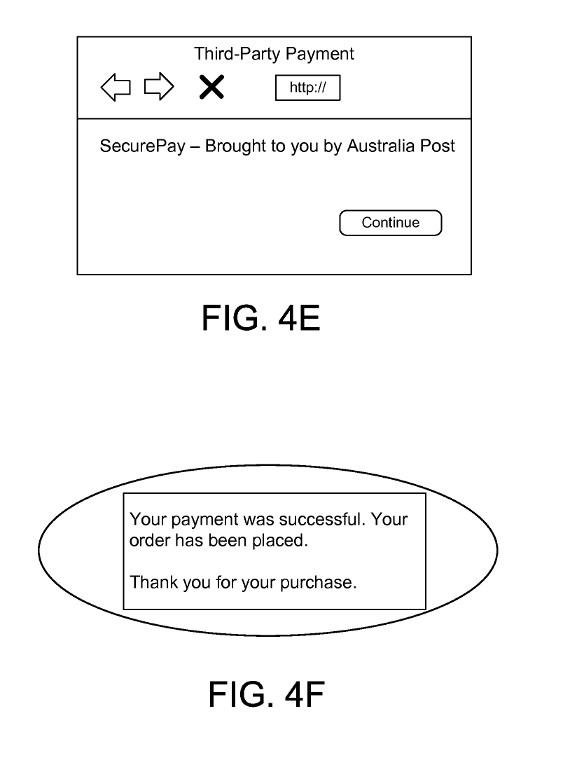

However, the cross-border buyer 304 faces payment and shipping complexity when buying on the U.S. based online marketplace (e.g., the publication system 120). The publication system 120 (e.g., the CBT engine 224) detects this potential roadblock and redirects the cross-border buyer 304 to a cross-border buying agent-assisted checkout and payment flow (also referred to as “CBA buyer flow”). The CBA buyer flow will be discussed in more detail in connection with FIG. 4A-FIG. 4F below.

Since one frequent impediment for the cross-border buyer 304 is international payment (e.g., from China), the publication system 120 may allow the cross-border buyer 304 to pay in a local payment method. In some embodiments, the cross-border buyer 304 provides payment using a local payment processor, which is provided to the buying agent 302. The buying agent 302, in turn, may pay the seller 306 and other third parties involved in the transaction (e.g., customs handlers). Payment by the cross-border buyer 304 may include all related fees including international shipping, import duty, and buying agent service fees. In some cases, the price of the item may automatically include all of these fees.

Subsequently, the publication system 120 (e.g., the CBT engine 224) detects the payment made by the cross-border buyer 304. In response, the publication system 120 instructs the seller 306 to ship the item. Since another frequent hassle is international shipping, the publication system 120 (e.g., the CBT engine 224) may instruct the seller 306 to ship the item to a U.S. based warehouse or location operated by the buying agent 302. This process saves the seller 306 from the complexity of cross-border shipping such as dealing with customs procedures.

Once the item/merchandise reaches the U.S. based warehouse (or location) of the buying agent 302, the buying agent 302 assumes responsibility for the item (e.g., goods and services) on behalf of the cross-border buyer 304 from that point on. As such, the buying agent 302 assumes responsibility for handling international shipping, paying import duty, and paying shipping charges to the final destination. In one embodiment, the buying agent 302 may compile a plurality of purchased items and ship in bulk to a buying agent-operated warehouse or location in a foreign country where the buyers are located. By shipping in bulk, the buying agent 302 may reduce international shipping charges that would be incurred if each item were shipped internationally separately. Once the items are in the foreign country, the individual items may then be shipped or transported to the individual buyers using local delivery channels. The buying agent 302 may also cover customer support and post-fulfillment issues including merchandise returns and warranties.

When integrated into the U.S. based online marketplace website (e.g., the publication system 120), the buying agent 302 becomes a CBT-extension to an otherwise seller-domestic transaction. Seller-domestic refers to the fact that the seller 306 can treat the transaction as wholly domestic, oblivious to the fact that the cross-border buyer 304 resides overseas or across a border. This is made possible by the services provided by the buying agent 302.

In example embodiments, the flow works by injecting a cross-border buying agent option in the buying experience. One embodiment of an example cross-border buying assistant (CBA) buyer flow is presented in FIGS. 4A-4F.

FIG. 4A illustrates a portion of a screenshot of a user interface for providing the CBA buyer flow option. In FIG. 4A, a “Buy With CBA” button is presented as an option on a view-item page, listing, or publication for an item available on the U.S. based online marketplace (e.g., the publication system 120). In particular, when the cross-border buyer visits the U.S. based online marketplace (e.g., eBay.com or any other online store, auction site, or classified ad site), a marketplace platform (e.g., the CBT engine 224) offers the buyer an option of a CBA buyer flow to facilitate a CBT. In one scenario, this option (“Buy With CBA”) is presented on the view-item page/listing as an alternative, or in addition, to the “Buy It Now” (or “Bid”) option. The cross-border buyer may be an individual having a foreign registered address and/or foreign shipping address (e.g., foreign relative to the seller or online marketplace). The cross-border buyer may be identified, for example, based on their IP address or based on their profile with the online marketplace as being overseas or cross-border. It is noted that while the term “overseas” is used, example embodiments are directed to any cross-border (and not necessarily transcending a body of water) buyer and transaction. Additionally, “border” may refer to jurisdictions, and example embodiments may be used for cross-jurisdictional transactions. For example, example embodiments may be used in a sale of wine across different states in the U.S. that have complex shipping logistics and where different laws prevent effective and easy commerce across state lines.

In one embodiment, once the cross-border buyer selects the “Buy With CBA” option, a portion of a screenshot of a user interface as shown in FIG. 4B may be presented. In one example, the buying agent (or CBT engine 224) may request the buyer to enter one or more of a destination address, package weight and dimensions, and a shipping option. While the buyer can request weight and dimensions of the package from the seller, in alternative embodiments, some of this information (e.g., package weight and dimensions) may be obtained by the buying agent from the listing or be provided by the U.S. based online marketplace (e.g., the buyer's address may be obtained from their profile stored with the U.S. based online marketplace) or from the listing (e.g., provided by the seller). Portions of this operation may be optional in some embodiments (e.g., only the buyer's address or only a selection of a shipping option may be required), or the entire operation shown in FIG. 4B may be optional or not needed in various embodiments.

Referring now to FIG. 4C, the buyer is presented with a list of one or more available cross-border agents (“CBAs”) for their domestic location that are qualified or approved by the online marketplace or seller. The list of available CBAs may be customized to the buyer based on past usage by the buyer, buyer preferences (e.g., from the buyer profile), buyer default (e.g., set up in the buyer profile), ratings corresponding to each CBA, or any other attribute. In some embodiments, the list may be ordered by preference or ratings (e.g., feedback score), and may differentiate between CBAs that offer cash-on-delivery as an option versus CBAs that require payment upfront from the buyer. The list may include information such as CBA feedback, estimated delivery date, and total price using that particular CBA (e.g., including service fees for use of the CBA and other fees such as warranty fees), along with an option to chat with the CBA. The list may be presented in a pop-up window or a drop down menu in some cases. In some embodiments, a selected CBA may be set up to be a default by the buyer for future purchases. In some embodiments, the list of CBAs available to the buyer may also be determined and customized by incorporating preferences, information, and implicit and explicit instructions provided by the seller. The networked system 102 may also take into consideration other sources of data to determine whether to even display CBAs, which CBAs to display, and in which order, such as, information on the legality of the transaction and/or compliance with policies (e.g., to comply with intro jurisdictional commerce law such as sales of wine between U.S. states, sales of weapons such as knifes, or products of certain origin such as Cuban cigars across borders).

In example embodiments, the CBT engine 224 may compute a total price based on buyer address, package weight and dimensions, import duty, CBA service fee(s), and the seller-domestic shipping fee. A detailed breakdown of the total price may be presented to the cross-border buyer, as shown in FIG. 4D, once the cross-border buyer selects one of the CBAs. Additionally, the cross-border buyer may select a payment method to pay for the item. Thus, once the cross-border buyer selects a CBA, a CBA payment flow may be triggered.

In example embodiments, the cross-border buyer may be redirected to a buyer-local (possibly third-party buyer-local) payment processor (e.g., for non-cash-on-delivery embodiments). For example, if the cross-border buyer is located in Australia, the cross-border buyer may be directed to a third-party payment processor in Australia as shown in FIG. 4E. The cross-border buyer may pay the CBA and completes payment for the item. The CBA may then send payment to the seller and the U.S. based online marketplace. In an alternative embodiment, the cross-border buyer may guarantee payment to the CBA upon delivery and the CBA floats the purchase price. In yet another embodiment, the cross-border buyer may pay the U.S. based online marketplace and the U.S. based online marketplace may distribute payment to the seller and the CBA.

Behind the scene, the CBT engine 224 may complete the transaction based on the payment and/or close the purchase of the item using funds either provided by the buyer or the CBA. A confirmation message may be presented to the buyer as shown in FIG. 4F.

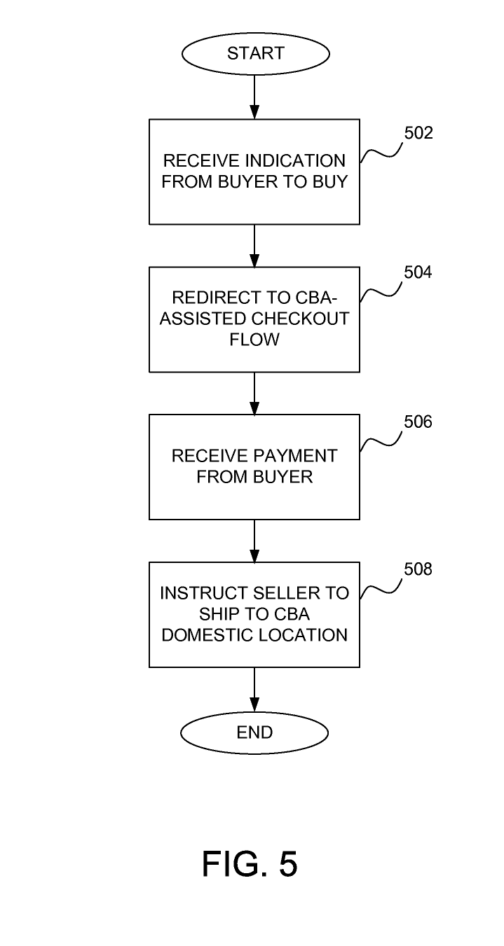

Referring now to FIG. 5, a flowchart of an example method 500 for providing cross-border buying assistance is shown. The operations of FIG. 5 may be performed by the CBT engine 224. In operation 502, an indication is received from the cross-border buyer to purchase an item using a buying agent. In some cases, the cross-border buyer may select from a list of one or more buying agents or be recommended one or more buying agents based on a profile of the cross-border buyer (e.g., based on a previous transaction), preferences and criteria of the seller, past transaction history of the buying agent, or any combination of these.

In operation 504, the cross-border buyer may be redirected to a cross-border agent (CBA) assisted checkout flow. In one embodiment, the cross-border buyer may be redirected to a buyer-local payment processor (e.g., a payment processor located in the same country as the buyer).

In operation 506, payment (or confirmation of the payment) is received from the cross-border buyer. In one embodiment, the cross-border buyer may pay the buying agent. The buying agent may then send payment to the seller and the U.S. based online marketplace. Alternatively, the cross-border buyer may guarantee payment to the buying agent upon delivery and the buying agent floats the purchase price (e.g., pays the seller and the U.S. based online marketplace and then collects from the cross-border buyer). In yet another embodiment, the cross-border buyer may pay the U.S. based online marketplace, and the U.S. based online marketplace may distribute payment to the seller and the buying agent.

Once payment is made to the seller, either from the cross-border buyer or the buying agent, in operation 508, the CBT engine 224 instructs the seller to ship the item to a domestic location of the buying agent. When the item is received by the buying agent, the buying agent is responsible for managing any issues related to the item. For example, the buying agent assumes international shipping and may assume import duty. The buying agent may also handle overseas or cross-border customer support, such as managing returns, offering local warranties, and other support/services.

While embodiments were discussed above with the cross-border buyer accessing the U.S. based online marketplace or networked commerce system and the option to use a buying agent provided by the listing, alternative embodiments may comprise the buying agent hosting an online marketplace or networked commerce system local to the cross-border buyer (e.g., within China or Russia) that “floats” inventory from the U.S. based online marketplace. The hosted networked commerce system may be a local website, store, mobile app, kiosk, or any other embodiment of a networked commerce system available to the buyer that is linked to the U.S. based online marketplace and may pull inventory and listing descriptions from the U.S. based online marketplace. In these embodiments, the buying agent may be a partner of the U.S. based online marketplace and may be provided with tools (e.g., components of the CBT engine 224, such as a “finding” API of the U.S. based online marketplace) to enable the linking of the inventory. For example, the buying agent may have access to a tool that allows the buying agent to select certain items or certain categories that the buying agent believes will sell in their local marketplace. In some cases, the buying agent may select items with multiple quantities to insure that when time comes to purchase the item from the U.S. based online marketplace, the item is still available. The item descriptions are pulled to the buying agent hosted network commerce system, and the buying agent may translate the item descriptions to a local language for display on the buying agent hosted online marketplace. In an alternative embodiment, listings offered on the domestic online marketplace may be linked to a third party networked commerce system of the buying agent's choosing in the targeted buyer's jurisdiction. For example, a buying agent in China may link listings from a U.S. based online marketplace and publish the listings on the third party site and offer his services on that third party site.

When a cross-border buyer selects to purchase an item found on the CBA (or third party) hosted network commerce system, the buying agent collects information and/or payment from the cross-border buyer to complete the transaction. The buying agent may then go to the U.S. based online marketplace and purchase the item from a seller that has offered the item for sale on the U.S. based online marketplace (e.g., just-in-time buying using a trading API for orders). As such, the buying agent is the buyer on the U.S. based online marketplace from the U.S. seller perspective. Similar to the “buy through the CBA” embodiment discussed above, the item may be shipped to a U.S. location of the buying agent and then shipped, by the buying agent, across the border to a destination country of the cross-border buyer where local delivery to the cross-border buyer is performed. It is noted that a price of the item on the buying agent hosted online marketplace may automatically account for shipping fees and buying agent service fees. In some embodiments, the tool may automatically calculate these fees when determining a listing price on the buying agent online marketplace.

While example embodiments discussed above are directed to purchase of items at a set price, alternative embodiments may contemplate using the buying agent as a proxy for bidding on auction items. In these cases, the cross-border buyer may provide a maximum amount that they are willing to bid on an item. That amount may include the fees for the buying agent (including shipping fees). Alternatively, the fees for the buying agent may be separately indicated. If the cross-border buyer wins the auction, the shipping/delivery flow will be the same as discussed above.

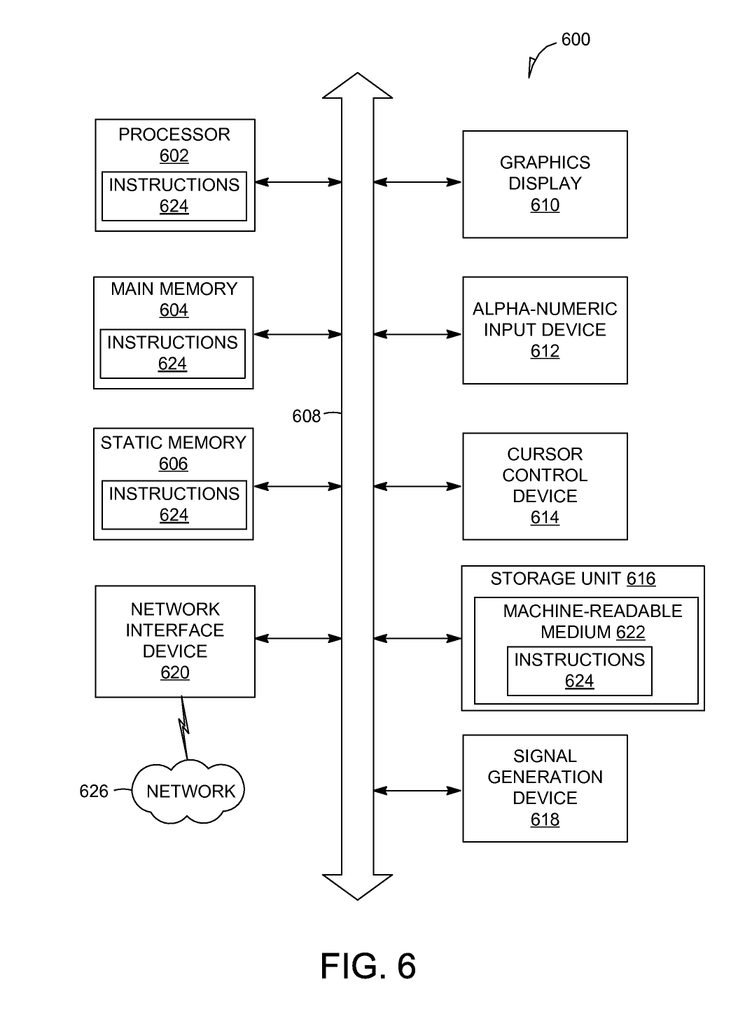

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the machine-readable medium is non-transitory in that it does not embody a propagating signal. However, labeling the machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A non-transitory machine-readable medium in communication with at least one processor, the non-transitory machine-readable medium storing instructions which, when executed by the at least one processor of a machine, cause the machine to perform operations comprising:
providing an option to a cross-border buyer to purchase an item from a domestic networked commerce system using a buying agent; and
based on a purchase of the item using the buying agent, sending instructions to a seller of the item to ship the item to a domestic location corresponding to the buying agent, the buying agent to manage delivery of the item to the cross-border buyer from the domestic location.

2. The non-transitory machine-readable medium of claim 1, wherein the operations further comprise providing a list of one or more buying agents from which the cross-border buyer selects the buying agent.

3. The non-transitory machine-readable medium of claim 2, wherein the operations further comprise recommending buying agents on the list based on a profile of the cross-border buyer.

4. The non-transitory machine-readable medium of claim 2, wherein the operations further comprise recommending buying agents on the list based on past transaction data related to each of the buying agents.

5. The non-transitory machine-readable medium of claim 2, wherein the list indicates an estimated arrival date for the item for each service offered by the one or more buying agents.

6. The non-transitory machine-readable medium of claim 2, wherein the list indicates a total price for each of the one or more buying agents, the total price comprising one or more of an item price, a shipping fee, customs duty, and a buying agent fee.

7. The non-transitory machine-readable medium of claim 2, wherein the operations further comprise using seller preferences and criteria in selecting the one or more buying agents on the list.

8. The non-transitory machine-readable medium of claim 1, wherein the operations further comprise redirecting the cross-border buyer to a payment processor domestic to the cross-border buyer.

9. The non-transitory machine-readable medium of claim 1, wherein the operations further comprise receiving payment, at a domestic payment processor associated with the domestic networked commerce system, from the buying agent on behalf of the cross-border buyer.

10. The non-transitory machine-readable medium of claim 1, wherein the operations further comprise:
receiving, at a domestic payment processor associated with the domestic networked commerce system, payment from the cross-border buyer;
distributing a first portion of the payment to the seller; and
distributing a second portion of the payment to the buying agent.

11. The non-transitory machine-readable medium of claim 1, wherein the operations further comprise linking listings offered on the domestic networked commerce system to a networked commerce system hosted by the buying agent.

12. The non-transitory machine-readable medium of claim 1, wherein the operations further comprise linking listings offered on the domestic networked commerce system to a third party networked commerce system chosen by the buying agent in a jurisdiction of the cross-border buyer.

13. A method comprising:
providing, using a hardware processor, an option to a cross-border buyer to purchase an item from a domestic networked commerce system using a buying agent; and
based on a purchase of the item using the buying agent, sending instructions to a seller of the item to ship the item to a domestic location corresponding to the buying agent, the buying agent to manage delivery of the item to the cross-border buyer from the domestic location.

14. The method of claim 13, further comprising providing a list of one or more buying agents from which the cross-border buyer selects the buying agent.

15. The method of claim 14, further comprising recommending buying agents on the list based on at least one of a profile of the cross-border buyer, past transaction data related to the buying agents, or seller preferences and criteria.

16. The method of claim 14, wherein the list indicates an estimated arrival date for each of the one or more buying agents.

17. The method of claim 14, wherein the list indicates a total price for each of the one or more buying agents, the total price comprising one or more of an item price, a shipping fee, customs duty, or a buying agent fee

18. The method of claim 13, further comprising receiving payment, at a domestic payment processor associated with the domestic networked commerce system, from the buying agent on behalf of the cross-border buyer.

19. The method of claim 13, further comprising:
receiving, at a domestic payment processor associated with the domestic networked commerce system, payment from the cross-border buyer;
distributing a first portion of the payment to the seller; and
distributing a second portion of the payment to the buying agent.

20. A system comprising:
a hardware processor; and
a cross-border transaction engine to:
provide, using the hardware processor, an option to a cross-border buyer to purchase an item from a domestic networked commerce system using a buying agent; and
based on a purchase of the item using the buying agent, send instructions to a seller of the item to ship the item to a domestic location corresponding to the buying agent, the buying agent to manage delivery of the item to the cross-border buyer from the domestic location.
